(19) United States
(12) Patent Application Publication
(10) Pub. No.: US 2021/0124667 A1
(43) Pub. Date: Apr. 29, 2021

(54) TECHNIQUES FOR DETECTING PERFORMANCE ISSUES IN VIDEO PROCESSING

(71) Applicant: Microsoft Technology Licensing, LLC, Redmond, WA (US)

(72) Inventors: Shu-Wei Hsu, Redmond, WA (US); William Jarrad Bailey, Mercer Island, WA (US); Sebastian Carl Merry, Kirkland, WA (US)

(21) Appl. No.: 16/667,575

(22) Filed: Oct. 29, 2019

(51) Int. Cl. G06F 11/34; G06N 3/04; G06N 3/08

(52) U.S. Cl. CPC G06F 11/3409; G06N 3/08; G06N 3/04

(57) ABSTRACT

Examples described herein generally relate to detecting potential issues in video processing. For each of multiple instances of time over a time period, a set of values corresponding to different performance metrics related to video processing can be obtained. A data structure can be generated to include the set of values. The data structure can be compared to a set of data structures in a convolutional neural network (CNN) model. Based on comparing the data structure to the set of data structures, it can be determined whether the set of values represent a potential issue in video processing or not.

### BACKGROUND

Use of computing devices is becoming more ubiquitous by the day. Computing devices range from standard desktop computers to wearable computing technology and beyond. Computing devices typically include one or more display devices for displaying visual content as output to a user, and the computing devices typically include hardware for generating the visual content for display, such as a graphics processing unit (GPU) or other processors. An operating system of the computing device can execute a graphics driver to communicate rendering instructions to the GPU to cause display of visual content. Computing devices can accordingly process video for displaying on the display, which can be used in rendering visual content for passive consumption, rendering visual content in games where a user is more immersed, and/or the like. As processing resources are limited at the computing device, video processing can often be imperfect, and can have noticeable (or unnoticeable) defects, such as frame-per-second (FPS) stutter where frames may not be fully rendered in an allotted period of time. In a gaming scenario, for example, such FPS stutter, when it occurs at a threshold rate, can impact gameplay, which can provide an undesirable user experience.

In addition, machine learning (ML) has been employed to perform image identification where, given an input image, the input image can be compared using a model of images in an attempt to detect or identify parts of the image, such as a type of object in the image, a face of a person in the image, etc. In these systems, convolutional neural networks (CNNs) can provide a ML model that can be trained using various images and associated tags, where the tags can be specified or can be automatically detected (e.g., as similar properties in different images) as part of the training process. The ML model is trained to gather data from images having the same tag, and can attempt to identify parts of an input image by comparing the input images to collections of tagged images in attempt to identify a tag in the input image. CNNs use various convolution layers to distil the input image and compare features thereof to identify the parts of the input image.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In an example, a method for detecting performance issues in video processing is provided. The method includes obtaining, for each of multiple instances of time over a time period, a set of values corresponding to different performance metrics related to video processing, generating a data structure that includes the set of values, comparing the data structure to a set of data structures in a convolutional neural network (CNN) model, wherein the set of data structures have other values for the different performance metrics over the time period, and determining, based on comparing the data structure to the set of data structures, whether the set of values represent a potential issue in video processing or not.

In another example, a computing device for detecting performance issues in video processing is provided that includes a memory storing one or more parameters or instructions for executing an operating system and a plurality of applications, a display interface coupled with a display device for communicating signals to display visual content on the display device, and at least one processor coupled to the memory and the display interface. The at least one processor is configured to obtain, for each of multiple instances of time over a time period, a set of values corresponding to different performance metrics related to video processing, generate a data structure that includes the set of values, compare the data structure to a set of data structures in a CNN model, wherein the set of data structures have other values for the different performance metrics over the time period, and determine, based on comparing the data structure to the set of data structures, whether the set of values represent a potential issue in video processing or not.

In another example, A non-transitory computer-readable medium including comprising code executable by one or more processors for detecting performance issues in video processing is provided. The code includes code for obtaining, for each of multiple instances of time over a time period, a set of values corresponding to different performance metrics related to video processing, generating a data structure that includes the set of values, comparing the data structure to a set of data structures in a CNN model, wherein the set of data structures have other values for the different performance metrics over the time period, and determining, based on comparing the data structure to the set of data structures, whether the set of values represent a potential issue in video processing or not.

To the accomplishment of the foregoing and related ends, the one or more examples comprise the features hereinafter fully described and particularly pointed out in the claims. The following description and the annexed drawings set forth in detail certain illustrative features of the one or more examples. These features are indicative, however, of but a few of the various ways in which the principles of various examples may be employed, and this description is intended to include all such examples and their equivalents.

### BRIEF DESCRIPTION OF THE DRAWINGS

FIG. 1 is a schematic diagram of an example of a computing device and display device communicatively coupled for displaying visual content in accordance with examples described herein.

FIG. 2 illustrates a schematic diagram of an example of an issue detecting component in accordance with examples described herein.

FIG. 3 is a flow diagram of an example of a method for detecting issues in video processing in accordance with examples described herein.

FIG. 4 is a flow diagram of an example of a method for training a machine learning model in accordance with examples described herein.

FIG. 5 illustrates examples of graphical representations of performance metrics in accordance with examples described herein.

FIG. 6 is a schematic diagram of an example of a computing device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various examples related to identifying performance issues in video processing. In some examples, values of different performance metrics obtained during video processing can be correlated over a time period and compared to other sets of values for the performance metrics specified for time periods of similar length to determine whether a potential performance issue exists in the video processing. For example, machine learning (ML) can be used in this context to train a model using sets of values for the performance metrics corresponding to the time periods of similar length, where the various sets of values can relate to performance issues in video processing (and/or may include sets of values related to no performance issues in the video processing). Obtained inputs of sets of values can be compared to those in the model to determine whether potential processing issues exist in the video processing (or a likelihood of processing issues). Based on detecting the potential processing issues, for example, the processing issue(s) may be reported and/or one or more remedial actions may be initiated.

The model may correspond to a convolutional neural network (CNN) including the various sets of values of the performance metrics. In addition, a given set of values may also include a tag identifying the set of values are related to a processing issue (or not related to a processing issue). In this regard, CNN-based functions can be performed on input data to determine whether performance issues may exist in video processing based on comparing input data to the various sets of values in the CNN. In one specific example, the set of values for the performance metrics over the time period can be packed into different channels of a one-dimensional image, and the sets of values in the CNN can be similarly represented as one-dimensional images. For example, the one-dimensional image can include performance metrics packed as pixel values (e.g., red, green, blue (RGB) values), where each pixel can represent an instant in time over the time period. The CNN can be employed to compare an input one-dimensional image to sets of one-dimensional images determined to correspond to performance issues in video processing (or sets of one-dimensional images determined to correspond to video processing without performance issues). It can be accordingly determined whether the input one-dimensional image is indicative of a possible performance issue based on the results of the comparison using the CNN.

In one example, using a model in this regard can facilitate determination of performance issues using existing CNN functionality. Moreover, in one example, packing the performance metrics in image containers, such as a one-dimensional RGB collection of pixels, can facilitate processing using established image processing and/or comparison functionality (e.g., based on the CNN or otherwise). In addition, for example, using the model can facilitate determining performance issues for various types of video processing (e.g., in different gaming environments, on different computing devices, on different operating systems (OSs) or version of OSs, etc.) without necessarily using different thresholds, test cases, etc. for different video processing contexts. Furthermore, using analysis of performance metrics over a time period can facilitate allowing some noise or minor/sporadic fluctuation in performance metrics that may not necessarily yield identification of a performance issue that may otherwise result using a threshold comparison approach.

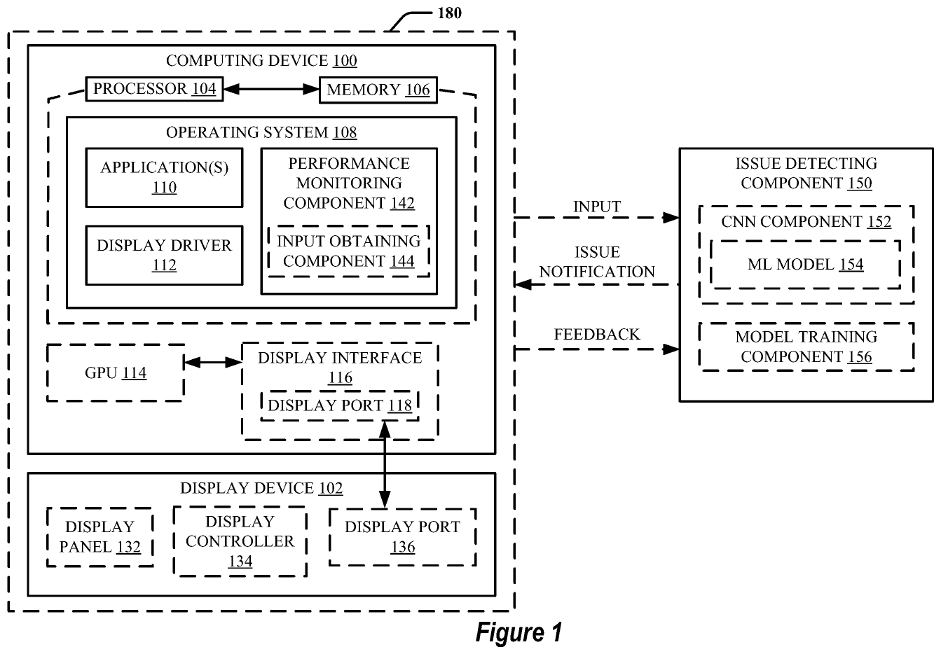

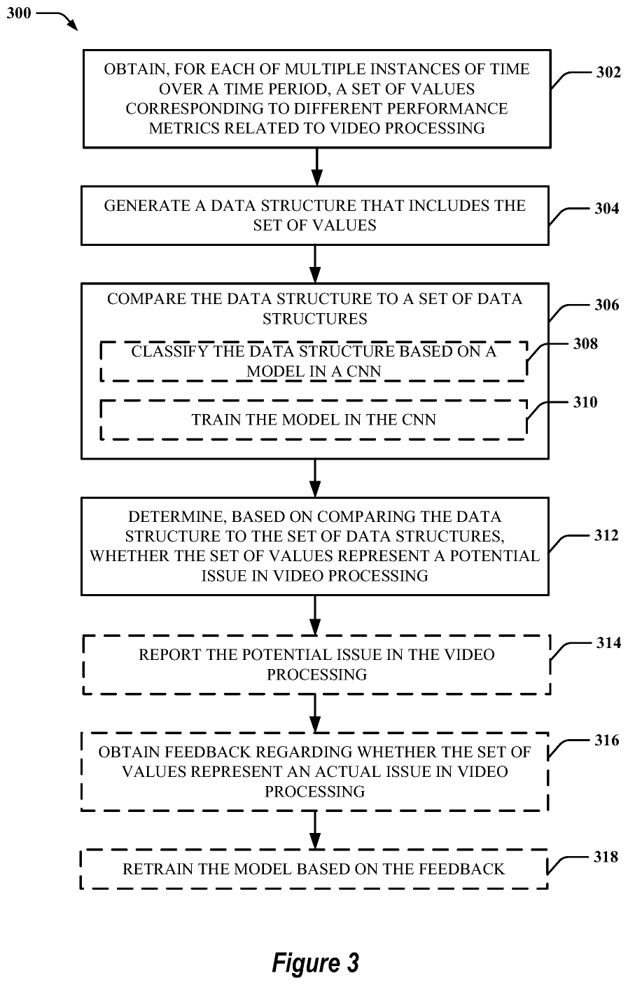

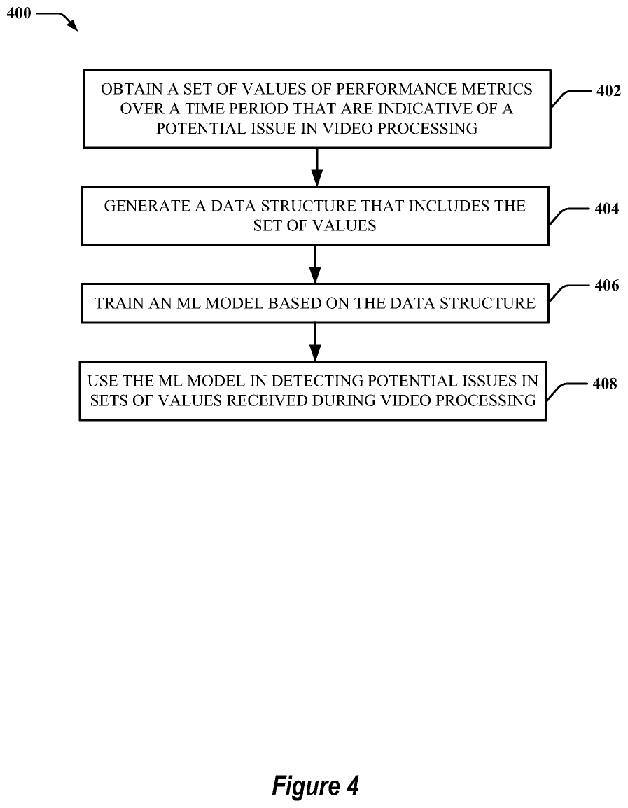

Turning now to FIGS. 1-6, examples are depicted with reference to one or more components and one or more methods that may perform the actions or operations described herein, where components and/or actions/operations in dashed line may be optional. Although the operations described below in FIGS. 3-4 are presented in a particular order and/or as being performed by an example component, the ordering of the actions and the components performing the actions may be varied, in some examples, depending on the implementation. Moreover, in some examples, one or more of the following actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a computing device 100, display device 102, and/or related components, which can communicate visual content data for displaying visual content on the display device 102. For example, the display device 102 may be an internal display that is within the same housing 180 as computing device 100, a display device that is external to, or remotely located from, computing device 100, and/or the like. In addition, for example, display device 102 may be coupled to computing device 100 via a display port, a wired or wireless network connection, etc. Display device 102 can be capable of displaying a two-dimensional display, such as a desktop, a three-dimensional world, etc.

For example, computing device 100 can include or can otherwise be coupled with a processor 104 and/or memory 106, where the processor 104 and/or memory 106 can be configured to execute or store instructions or other parameters related to communicating visual content data to the display device 102 for displaying, as described herein. Computing device 100 can execute an operating system 108 (e.g., via processor 104 and/or memory 106) for providing an environment for executing one or more applications 110, such as one or more applications 110 that produce or otherwise obtain visual content for display by the display device 102. For example, one or more applications 110 can include applications that produce video for rendering on the display device 102, such as a video game, a video playback application, etc. where the application 110 can present streams of images for display. The operating system 108 can also include a display driver 112 for communicating with a GPU 114 and/or with a display interface 116 of the computing device 100 (e.g., directly or via GPU 114) to cause rendering of visual content (e.g., one or more images) for display on the display device 102. In this example, the application 110 can utilize the GPU 114 to display the video and/or corresponding images on the display device 102.

In an example, display interface 116 can be communicatively coupled with the processor 104 and/or memory 106 for communicating with the display device 102 via a display port 118. Display port 118, as referred to herein, can include one or more of various types of ports, including a high definition multimedia interface (HDMI) port, a display serial interface (DSI) port, a mobile industry processor interface (MIPI) DSI port, a universal serial bus (USB) port, a Firewire port, or other embedded or external wired or wireless display ports that can allow communications between computing device 100 and display device 102.

For example, display device 102 can include a display panel 132 for displaying visual content based on signals received from a display controller 134. For example, the display panel 132 can include a CRT, LCD (which can include a light emitting diode (LED) backlit LCD display), organic LED (OLED) display, digital light processing (DLP) display, etc. Display device 102 can include, but is not limited to, a head-mounted display having a single display panel or multiple display panels (e.g., one for each of two eyes) to view on the head-mounted display, a monitor, a television, a projector, or substantially any type of embedded, external, wireless, etc., display configured for communicating with computing device 100 via an embedded, external, or wireless display port 136. As mentioned, display controller 134 provides signals to the display panel 132 to cause display of visual content. In an example, display controller 134 can include a printed circuit board (PCB), programmable logic controller (PLC), etc., coupled with the display panel 132 to control the display panel 132 to display visual content based on commands received via display port 136. Thus, for example, display controller 134 can be or can include a processor configured for sending the signals to the display panel 132 based on visual content data (e.g., rendered image frames) received via display port 136.

In an example, computing device 100 can generate visual content data for providing to the display device 102 for displaying visual content on display panel 132. Computing device 100 can accordingly communicate the visual content data to the display device 102 via display interface 116 using display port 118 to communicate signals corresponding to the visual content data to display port 136 for providing to display controller 134. In an example, operating system 108 and/or application 110 can obtain or otherwise generate visual content for displaying on display device 102, and display driver 112 can provide rendering instructions for rendering the visual content to GPU 114 (e.g., via display interface 116 or otherwise). In one example, GPU 114 can be part of the display interface 116 (e.g., a processor on a circuit board of the display interface 116). In another example, GPU 114, display interface 116, etc., can be integrated with processor 104. Substantially any combination of hardware can be possible such that GPU 114, display interface 116, etc., can communicate with processor 104 via a bus to facilitate providing the rendering instructions from the display driver 112 executing on the processor 104 (e.g., via the operating system 108) to the GPU 114. GPU 114 can process the rendering instructions to render visual content, and can initiate display of at least a portion of the visual content on the display device 102 by transmitting associated signals to the display device 102 via display port 118 of display interface 116. The display device 102 can receive the signals generated by the GPU 114, and display controller 134 can accordingly cause display panel 132 to draw or display the visual content based on the signals.

Computing device 100 may also include a performance monitoring component 142 that can monitor or obtain one or more performance metrics associated with displaying the visual content. For example, performance monitoring component 142 can execute via operating system 108, as an application, service, etc., to monitor the one or more performance metrics. In one example, performance monitoring component 142 can monitor a frames-per-second (FPS) metric representing how many frames-per-second the display device 102 is actually able to display. For example, performance monitoring component 142 can receive information from the display device 102, display interface 116, GPU 114, etc. indicating when a frame (e.g., an image in a video stream) is displayed on the display device 102 or otherwise sent to the display device 102 via display interface 116 (or when rendering instructions are processed into signals sent via display interface 116, etc.). For example, performance monitoring component 142 can accordingly determine how many frames are displayed per second based on the received information over a period of time.

In an example, FPS can be affected by, and can fluctuate according to, processing resources available on the computing device 100 (e.g., on the processor 104, memory 106, GPU 114, etc.), which can be impacted by various factors including operating system 108 issues or considerations, applications 110 executing, etc. Thus, the FPS achievable by the computing device 100 may fluctuate over time, and the number or magnitude of fluctuations may represent a potential issue in video processing, as described above and further herein. In another example, performance monitoring component 142 can determine other performance metrics, such as central processing unit (CPU) utilization (e.g., utilization of processor 104), memory 106 utilization, GPU 114 utilization, etc. over a period of time. Performance monitoring component 142 can optionally include an input obtaining component 144 for obtaining performance metrics over a time period, for potentially providing to other components of the computing device 100 or other computing devices (not shown).

In addition, an issue detecting component 150 can be provided for detecting potential issues in video processing. For example, issue detecting component 150 may be part of computing device 100 and/or may be part of another computing device (not shown) that receives performance metrics from other computing devices and processes the metrics to detect potential video processing issues. In either case, issue detecting component 150 can include, for example, a CNN component 152 to assist in detecting potential issues in video processing at least in part by comparing a data set of values of one or more performance metrics over a time period to stored data sets of values of the one or more performance metrics over a time period of similar length, where the stored data sets of values may be indicative of an issue in video processing, such as stuttering (or indicative of no issue, i.e., normal video processing).

CNN component 152, in an example, can include a ML model 154 that includes the various stored data sets of values, which may each be identified as one of a data set related to a potential issue or related to no potential issues. In addition, in an example, model training component 156 can train the ML model 154 with synthesized or actual data sets that relate to a potential issue or relate to no potential issue, as described further herein. In any case, in an example, issue detecting component 150 can receive input of a set of data values for one or more performance metrics over a time period (e.g., from input obtaining component 144), and can determine whether one or more potential issues related to video processing exist based on the input. Issue detecting component 150 may report any potential issues, which may include displaying an issue on an interface or in a log file, providing an issue notification to the computing device 100, and/or the like. In yet another example, issue detecting component 150 may receive feedback indicating whether the potential issue is considered an actual issue in the video processing, which can be used to further retrain the ML model 154 for subsequent potential issue detecting.

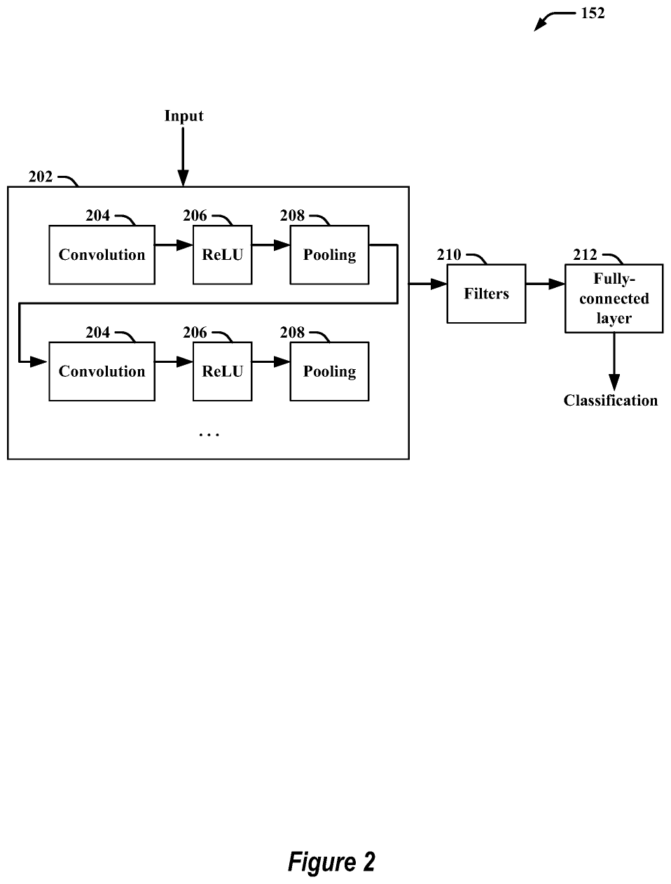

FIG. 2 illustrates an example of a CNN component 152, which can include a chain 202 of computation layers that may include one or more of a convolution operation 204, a rectified linear unit (ReLU) 206, and/or a pooling operation 208 to apply to an input set to extract features therefrom. These can be matrix operations used to detect features (e.g., temporal features) of the input. CNN component 152 can also include one or more filters 210 to flatten or vectorize resulting matrix values from the computation layers. CNN component 152 can also include a fully-connected layer 212 that can be used to identify features of the input to determine whether the input relates to a potential issue in video processing.

In a specific example, the input can be a one-dimensional image having pixel values corresponding to performance metrics, as described further herein. The input image can accordingly be provided to the chain 202 of computation layers to extract features therefrom using convolution operations 204, ReLUs 206, pooling operations 208, etc. The output can be filtered 210 to flatten the identified features, and the fully-connected layer 212 can classify the input based on comparing the features to features of known potential issues in video processing in the model.

FIG. 3 is a flowchart of an example of a method 300 for detecting potential issues in video processing. For example, method 300 can be performed by a computing device 100 and/or display device 102 communicatively coupled with one another and/or using an issue detecting component 150, which may be part of computing device 100 or another computing device, and is accordingly described with reference to FIGS. 1 and 2, for example.

In method 300, at action 302, a set of values corresponding to different performance metrics related to video processing can be obtained for each of multiple instances of time over a time period. In an example, input obtaining component 144, e.g., in conjunction with processor 104, memory 106, operating system 108, performance monitoring component 142, etc., can obtain, for each of the multiple instances of time over the time period, the set of values corresponding to the different performance metrics related to video processing. In another example, action 302 may include issue detecting component 150 can receive the set of values from input obtaining component 144, and/or input obtaining component 144 can provide the set of values to the issue detecting component 150 based on one or more triggers, a request from issue detecting component 150, a request from an interface on computing device 100 (e.g., via one or more applications 110), and/or the like. For example, where obtaining the set of values is for the purpose of possible issue detection, input obtaining component 144 can provide the set of values as input to the issue detecting component 150.

For example, as described, performance monitoring component 142 can monitor the different performance metrics, such as FPS, CPU utilization, GPU utilization, etc., and input obtaining component 144 can request or otherwise receive values for the different performance metrics at instances of time (e.g., each second), and can collect the values over the time period (e.g., multiple seconds or other units of time, such as a 100 second window, units of frames, etc.). Thus, in one specific example, the set of values may include FPS as measured each second over a time period (i.e., window) of multiple seconds, and thus the set of values may include the FPS at each second over the time period (and/or similarly CPU utilization, GPU utilization, etc. at each second over the time period).

In method 300, at action 304, a data structure that include the set of values can be generated. In an example, input obtaining component 144 and/or issue detecting component 150, e.g., in conjunction with processor 104, memory 106, operating system 108, performance monitoring component 142, etc., can generate the data structure that includes the set of values. In one example, input obtaining component 144 can generate the data structure and can provide the data structure to issue detecting component 150. In another example, issue detecting component 150 can generate the data structure. In an example, the data structure can be generated as a one-dimensional image, where the values of the performance metrics can be packed into pixel values, and each pixel can represent an instance of time over the time period. In one example, each pixel can be an 8-bit value, which can represent integer values 0-255. Generating the data structure can include packing a representation of one or more performance metrics, such as FPS, CPU utilization, GPU utilization, etc. into the 8-bit values typically used to represent RGB color values. In a specific example, each color parameter can be used for one performance metric, and/or one performance metric can be packed into multiple color parameters (e.g., where more than 8-bits are used for more granularity), etc.

In method 300, at action 306, the data structure can be compared to a set of data structures. In an example, issue detecting component 150, e.g., in conjunction with processor 104, memory 106, operating system 108 of computing device 100 or another computing device (not shown), etc., can compare the data structures to a set of data structures. For example, issue detecting component 150 can compare the data structure including the set of performance metric values over the time period to a set of other data structures that include at least a set of the performance metrics values over another time period of similar length to the time period and/or a label indicating whether the data structure in the set represents a potential performance issue in video processing or not. Thus, based on comparing the data structure to the set and determining a similarity between the data structure and one or more other data structures in the set, issue detecting component 150 can determine a likelihood that the data structure and corresponding set of values relates to a potential performance issue in video processing or not.

In a specific example, in comparing the data structure at action 306, optionally at action 308, the data structure can be classified based on a model in a CNN. In an example, CNN component 152, e.g., in conjunction with processor 104, memory 106, operating system 108 of computing device 100 or another computing device (not shown), issue detecting component 150, etc., can classify the data structure based on a model (e.g., ML model 154) in the CNN. For example, CNN component 152 can train the ML model 154, as described further herein, using actual or synthetic sets of data structures, which can also include labels indicating whether a given data structure relates to a performance issue in video processing (e.g., stuttering) or relates to no performance issue (e.g., normal video processing or no stuttering, etc.). For example, the sets of data structures, as described, can include values for the performance metrics over a time period that is similar in length to the time period corresponding the data structure constructed from the input. For example, a label of “stuttering” can be provided for sets of data structures that represent a level of stuttering that is noticeable or impactful to user experience, where a label of “no stuttering” can be provided to sets of data structures can still have some stuttering, but the stuttering is determined to not be noticeable or impactful to user experience.

In an example, in comparing the data structure at action 306, optionally at action 310 (or as an action occurring separately from method 300, as described further herein), the model in the CNN can be trained. In an example, model training component 156, e.g., in conjunction with processor 104, memory 106, operating system 108 of computing device 100 or another computing device (not shown), issue detecting component 150, CNN component 152, etc., can train the model in the CNN. Model training component 156 can train the ML model 154 by extracting features from the training set of data structures and associating the features with the appropriate label in ML model 154, as described further herein. Accordingly, for example, in classifying the data structure based on the ML model 154, model training component 156 can extract features from the data structure received as input, and can attempt to classify the input data structure based on the ML model 154 and identifying similar features of other data structures labeled as relating to potential performance issues (e.g., stuttering) or related to no potential performance issues (e.g., no stuttering). In other examples described further herein, other labels can be used to represent a degree of stuttering, etc.

In method 300, at action 312, it can be determined, based on comparing the data structure to the set of data structures, whether the set of values represent a potential issue in video processing. In an example, issue detecting component 150, e.g., in conjunction with processor 104, memory 106, operating system 108 of computing device 100 or another computing device (not shown), etc., can determine, based on comparing the data structure to the set of data structures, whether the set of values represent a potential issue in video processing (e.g., whether the values correspond to stuttering or no stuttering). For example, a similarity in values may be determined based on the comparison, and the similarity can lead to a determination of whether there is a potential issue in video processing, such as stuttering (e.g., where the values of the data structure are similar enough to values in the set of data structures that represent stuttering in video processor or represent no stuttering in video processing).

In an example, issue detecting component 150 can determine whether the set of values represent a potential issue in video processing based on classifying the data structure using CNN component 152. For example, where CNN component 152 classifies the data structure as representing a potential issue in video processing, issue detecting component 150 can determine there is a potential issue in the video processing. In a specific example, given the data structure as input (e.g., as a one-dimensional image or other structure), CNN component 152 can process the data structure based on the ML model 154 to extract features from the data structure and compare the extracted features to features of the trained data set to determine whether the input data structure can be classified as a potential performance issue in video processing. In an example, other labels can be used as well instead of only 1) relating to performance issue, and 2) related to no performance issue. For example, other categories of potential issue can be used (e.g., a numerical scale of severity of the issue), which may result in different reporting and/or remedial action results.

For example, referring back to FIG. 2, CNN component 152 can apply multiple computational operations in a chain 202 of computational operations to the data structure (e.g., the one-dimensional image) to extract features therefrom, where the operations may include applying one or more convolution matrices 204, ReLUs 206 (e.g., to filter out negative values resulting from the convolution operation), pooling operations 208 (e.g., to reduce the output size while keeping the most significant values), etc. In one example, feature extraction can also be based on the trained ML model 154 such to identify features that may be relevant for comparing to the trained data set generated from the labeled data structures described above. Additionally, CNN component 152 can apply the one or more filters 210 to flatten the matrix output to a vector output, and may use the fully-connected layer 212 to classify the vector output from the one or more filters 210. For example, classifying the vector can include selecting a classification relevant to the trained ML model 154 and associated data structures, such as a classification indicating performance issues or a classification indicating no performance issues.

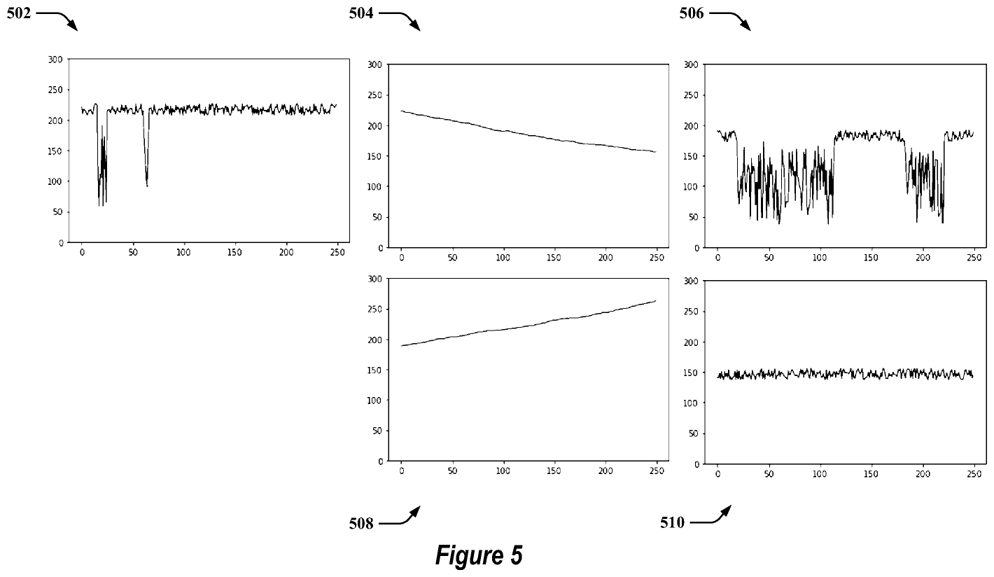

FIG. 5 illustrates examples of graphical representations of FPS over a time period that may relate to performance issues in video processing, such as stuttering, or no performance issues (e.g., no stuttering) in video processing. For example, graphical representations 502, 504, 506 can relate to performance issues in video processing. Graphical representation 502 shows multiple instances of relatively severe FPS degradation over the time period, graphical representation 504 shows consistent degradation in FPS over the time period, and graphical representation 506 shows mostly degraded FPS (and large fluctuations in FPS) over the period of time. Sets of performance metrics for these scenarios may be labeled as having performance issues. Graphical representation 508 shows consistent improvement in FPS over the time period, and graphical representation 510 shows fluctuating, but relatively consistent, FPS over the time period. Sets of performance metrics for these scenarios may be labeled as not having performance issues.

Thus, in one example, data structures for graphical representations, such as graphical representations 502, 504, 506, 508, and/or 510, can be used as training data sets to train the ML model 154, and CNN component 152 can accordingly classify an input data structure based on determining a similarity between data structures representing the graphical representations 502, 504, 506, 508, and/or 510, determining the labels for the graphical representations 502, 504, 506, 508, and/or 510, and weighting the labels based on the similarity with the input data structure (or features extracted therefrom).

In any case, for example, the data structure can be classified in this regard to determine whether the set of values represent a potential issue in video processing or not based on using CNN component 152 and ML model 154, as similarly used to detect image features, to determine whether the one-dimensional “image” representation of the performance metrics (or features thereof) are present based on a training set of similarly structured data.

In method 300, optionally at action 314, the potential issue in the video processing can be reported. In an example, issue detecting component 150, e.g., in conjunction with processor 104, memory 106, operating system 108 of computing device 100 or another computing device (not shown), etc., can report the potential issue in the video processing (e.g., where it is determined that the set of values represent the potential issue at action 312). For example, issue detecting component 150 can report the issue via an interface on a computing device on which the issue detecting component 150 executes, can report the issue to the computing device 100 from which the input is obtained (which may be the same or a different computing device, as described), etc. In one example, issue detecting component 150 may report additional information with the potential issue, such as time information, code information related to code in an application 110 that was executing when the issue was detected, etc. In another example, issue detecting component 150 may report the issue to one or more other applications 110 executing on the computing device 100, which may initiate a remedial action, such as increasing a priority for the application 110, closing one or more other applications or services, prompting for taking the remedial action, etc.

In one example, issue detecting component 150 may execute to continually monitor the application 110 that is processing video, by monitoring input at each of multiple continuous time periods, and may report any potential issues when detected. Using the image-based CNN to compare input performance metrics in this regard may allow for simplified and/or more efficient/diversified evaluation of performance metrics as compared to using threshold-based approaches.

Additionally, in method 300, optionally at action 316, feedback regarding whether the set of values represent an actual issue in video processing can be obtained. In an example, model training component 156, e.g., in conjunction with processor 104, memory 106, operating system 108 of computing device 100 or another computing device (not shown), etc., can obtain feedback regarding whether the set of values represent an actual issue in video processing. For example, based on reporting the potential issue or otherwise by allowing reporting of an observed issue, issue detecting component 150 can determine whether feedback is received indicating a potential issue is actually a perceived observable issue in video processing (e.g., as confirmed by a user consuming the video).

Where such feedback is received, in method 300, optionally at action 318, the model can be retrained based on the feedback. In an example, model training component 156, e.g., in conjunction with processor 104, memory 106, operating system 108 of computing device 100 or another computing device (not shown), etc., can retrain the ML model based on the feedback. For example, where the feedback indicates whether the set of values represent an actual issue in video processing, a label can be provided with the indication, and the set of value and/or corresponding data structure can be used to retrain the ML model 154, as described further herein.

FIG. 4 is a flowchart of an example of a method 400 for training a ML model with data sets representing issues in video processing (and/or representing no issues in video processing). For example, method 400 can be performed by a computing device 100 and/or display device 102 communicatively coupled with one another and/or using an issue detecting component 150, which may be part of computing device 100 or another computing device, and is accordingly described with reference to FIGS. 1 and 2, for example.

In method 400, at action 402, a set of values of performance metrics that are indicative of a potential issue in video processing can be obtained over a time period. In an example, issue detecting component 150, e.g., in conjunction with processor 104, memory 106, operating system 108 of computing device 100 or another computing device (not shown), can obtain a set of values of performance metrics over a time period that are indicative of a potential issue in video processing. For example, issue detecting component 150 can receive the set of values as one or more of an actual set of values of the performance metrics determined to relate to an actual performance issue in video processing (e.g., stuttering), a synthetic set of values generated to relate to an actual performance issue in video processing (e.g., stuttering), actual or synthetic values generate to relate to no performance issue in video processing (e.g., no stuttering), and/or the like. For example, a label of “stuttering” can be provided for a set of values that represents a level of stuttering that is noticeable or impactful to user experience, where a label of “no stuttering” can be provided to a set of values that can still have some stuttering, but the stuttering is determined to not be noticeable or impactful to user experience. For example, referring to FIG. 5, the sets of values may relate to performance metrics shown in one or more of graphical representations 502, 504, 506, 508, and/or 510, and/or may be associated with a label indicating performance issue or no performance issue.

In method 400, at action 404, a data structure that includes the set of values can be generated. In an example, issue detecting component 150, e.g., in conjunction with processor 104, memory 106, operating system 108 of computing device 100 or another computing device (not shown), can generate the data structure that includes the set of values. As described, for example, issue detecting component 150 can generate a one-dimensional image having pixel/color values that correspond to the set of values, such that the values can be treated as features for training an ML model 154.

In method 400, at action 406, an ML model can be trained based on the data structure. In an example, CNN component 152, e.g., in conjunction with processor 104, memory 106, operating system 108 of computing device 100 or another computing device (not shown), can train the ML model 154 based on the data structure. In one example, CNN component 152 can apply the chain 202 of computational operations to the data structure to extract features therefrom, the one or more filters 210 to vectorize the features, the fully-connected layer 212 to indicate the vector as related to a label for the data structure (e.g., an issue in video processing or no issue in video processing), etc. In one example, in training the ML model 154, CNN component 152 can start with random weights and/or convolution kernels, feed a portion of data structure and label pairs to the ML model 154, and can check prediction error (e.g., based on feedback). These actions can be performed over time and the weights can be modified based on gradient calculation to improve prediction error and accordingly tune the ML model 154. In one example, feedback can be used to determine accuracy of the ML model 154 and accordingly adjust weights, etc., as described above.

In method 400, at action 408, the ML model can be used in detecting potential issues in sets of values received during video processing. In an example, CNN component 152, e.g., in conjunction with processor 104, memory 106, operating system 108 of computing device 100 or another computing device (not shown), can use the ML model in detecting potential issues in sets of values received during video processing. For example, as described, CNN component 152 can classify sets of values based on generating a similar input data structure, as described, and determining whether features of the input data structure are similar to features in the data structures used to train the ML model 154 that correspond to issues in video processing or no issues in video processing. Other labels may be used as well, such as a degree of video processing issue (e.g., a numeric scale of performance desirability), and the other labels may be associated with input data structure and reported, as described herein.

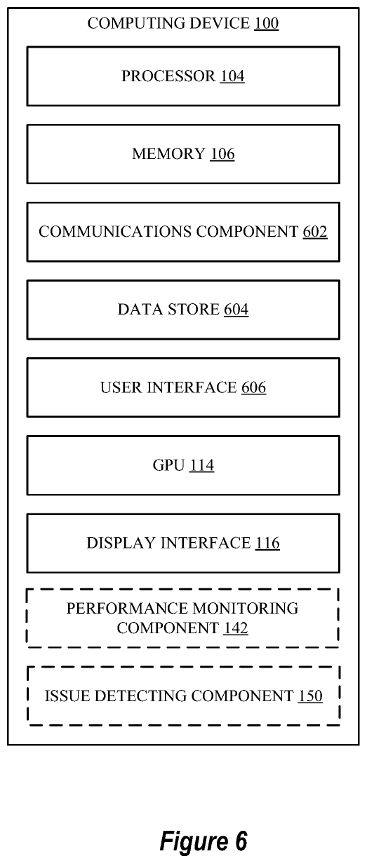

FIG. 6 illustrates an example of computing device 100 including additional optional component details as those shown in FIG. 1. In one example, computing device 100 may include processor 104 for carrying out processing functions associated with one or more of components and functions described herein. Processor 104 can include a single or multiple set of processors or multi-core processors. Moreover, processor 104 can be implemented as an integrated processing system and/or a distributed processing system.

Computing device 100 may further include memory 106, such as for storing local versions of applications being executed by processor 104, related instructions, parameters, etc. Memory 106 can include a type of memory usable by a computer, such as random access memory (RAM), read only memory (ROM), tapes, magnetic discs, optical discs, volatile memory, non-volatile memory, and any combination thereof. Additionally, processor 104 and memory 106 may include and execute an operating system executing on processor 104, one or more applications, display drivers, services, etc., as described herein, and/or other components of the computing device 100.

Further, computing device 100 may include a communications component 602 that provides for establishing and maintaining communications with one or more other devices, parties, entities, etc. utilizing hardware, software, and services as described herein. Communications component 602 may carry communications between components on computing device 100, as well as between computing device 100 and external devices, such as devices located across a communications network and/or devices serially or locally connected to computing device 100. For example, communications component 602 may include one or more buses, and may further include transmit chain components and receive chain components associated with a wireless or wired transmitter and receiver, respectively, operable for interfacing with external devices.

Additionally, computing device 100 may include a data store 604, which can be any suitable combination of hardware and/or software, that provides for mass storage of information, databases, and programs employed in connection with examples described herein. For example, data store 604 may be or may include a data repository for applications and/or related parameters not currently being executed by processor 104. In addition, data store 604 may be a data repository for an operating system, application, display driver, etc. executing on the processor 104, and/or one or more other components of the computing device 100.

Computing device 100 may also include a user interface component 606 operable to receive inputs from a user of computing device 100 and further operable to generate outputs for presentation to the user (e.g., via display interface 116 to a display device). User interface component 606 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, any other mechanism capable of receiving an input from a user, or any combination thereof. Further, user interface component 606 may include one or more output devices, including but not limited to a display interface 116, a speaker, a haptic feedback mechanism, a printer, any other mechanism capable of presenting an output to a user, or any combination thereof.

Computing device 100 can also include a GPU 114, as described herein, for rendering frames based on rendering instruction received from processor 104. GPU 114 can additionally send signals via a display interface 116 to cause display of the rendered frames on a display device. Computing device 100 may also include a performance monitoring component 142 for monitoring one or more performance metrics related to video processing, and/or an issue detecting component 150 for detecting issues in video processing, as described herein.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more examples, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various examples described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A computer-implemented method for detecting performance issues in video processing, comprising:
obtaining, for each of multiple instances of time over a time period, a set of values corresponding to different performance metrics related to video processing;
generating a data structure as a one-dimensional image including the set of values corresponding to the different performance metrics over the time period stored as pixel values in the one-dimensional image, wherein a first pixel value of a pixel of the one-dimensional image is a first value of the set of values that corresponds to a first performance metric, and wherein a second pixel value of the pixel of the one-dimensional image is a second value of the set of values that corresponds to a second performance metric;
comparing the one-dimensional image to a set of one-dimensional images in a convolutional neural network (CNN) model, wherein the set of one-dimensional images have other values for the different performance metrics over the time period stored as pixel values; and
determining, based on comparing the one-dimensional image to the set of one-dimensional images, whether the set of values represent a potential issue in video processing or not.

2. (canceled)

3. The computer-implemented method of claim 1, wherein the CNN model indicates, for each of the set of one-dimensional images, whether a given one-dimensional image in the set of one-dimensional images represents the potential issue in video processing or not.

4. The computer-implemented method of claim 3, wherein the determining whether the set of values represent the potential issue is based at least in part on determining whether the one-dimensional image is similar to a subset of the set of one-dimensional images indicated as having the potential issue in video processing.

5. The computer-implemented method of claim 1, wherein the different performance metrics include a measurement of frames-per-second.

6. The computer-implemented method of claim 5, wherein the different performance metrics further include a measurement of central processing unit (CPU) utilization or graphics processing unit (GPU) utilization.

7. The computer-implemented method of claim 1, further comprising training the CNN model with the set of one-dimensional images including at least one synthesized data structure or including at least one actual data structure received during performance of the video processing.

8. The computer-implemented method of claim 7, further comprising receiving the at least one actual data structure based on feedback from one or more applications.

9. The computer-implemented method of claim 1, further comprising reporting, to an interface, the potential issue in video processing.

10. The computer-implemented method of claim 1, wherein obtaining the set of values comprises obtaining the set of values from a computing device on which the video processing is occurring, which is different from a device on which the one-dimensional image is compared to the set of one-dimensional images.

11. A computing device for detecting performance issues in video processing, comprising:
a memory storing one or more parameters or instructions for executing an operating system and a plurality of applications;
a display interface coupled with a display device for communicating signals to display visual content on the display device; and
at least one processor coupled to the memory and the display interface, wherein the at least one processor is configured to:
obtain, for each of multiple instances of time over a time period, a set of values corresponding to different performance metrics related to video processing;
generate a data structure as a one-dimensional image including the set of values corresponding to the different performance metrics over the time period stored as pixel values in the one-dimensional image, wherein a first pixel value of a pixel of the one-dimensional image is a first value of the set of values that corresponds to a first performance metric, and wherein a second pixel value of the pixel of the one-dimensional image is a second value of the set of values that corresponds to a second performance metric;
compare the one-dimensional image to a set of one-dimensional images in a convolutional neural network (CNN) model, wherein the set of one-dimensional images have other values for the different performance metrics over the time period stored as pixel values; and
determine, based on comparing the one-dimensional image to the set of one-dimensional images, whether the set of values represent a potential issue in video processing or not.

12. (canceled)

13. The computing device of claim 11, wherein the CNN model indicates, for each of the set of one-dimensional images, whether a given one-dimensional image in the set of one-dimensional images represents the potential issue in video processing or not.

14. The computing device of claim 13, wherein the at least one processor is configured to determine whether the set of values represent the potential issue based at least in part on determining whether the one-dimensional image is similar to a subset of the set of one-dimensional images indicated as having the potential issue in video processing.

15. The computing device of claim 11, wherein the different performance metrics include a measurement of frames-per-second.

16. The computing device of claim 11, wherein the at least one processor is further configured to train the CNN model with the set of one-dimensional images including at least one synthesized data structure or including at least one actual data structure received during performance of the video processing.

17. The computing device of claim 11, wherein the at least one processor is further configured to report, to an interface, the potential issue in video processing.

18. The computing device of claim 11, wherein the at least one processor is configured to obtain the set of values from a device on which the video processing is occurring, which is different from the computing device.

19. A non-transitory computer-readable medium, comprising code executable by one or more processors for detecting performance issues in video processing, the code comprising code for:
obtaining, for each of multiple instances of time over a time period, a set of values corresponding to different performance metrics related to video processing;
generating a data structure as a one-dimensional image including the set of values corresponding to the different performance metrics over the time period stored as pixel values in the one-dimensional image, wherein a first pixel value of a pixel of the one-dimensional image is a first value of the set of values that corresponds to a first performance metric, and wherein a second pixel value of the pixel of the one-dimensional image is a second value of the set of values that corresponds to a second performance metric;
comparing the one-dimensional image to a set of one-dimensional images in a convolutional neural network (CNN) model, wherein the set of one-dimensional images have other values for the different performance metrics over the time period stored as pixel values; and
determining, based on comparing the one-dimensional image to the set of one-dimensional images, whether the set of values represent a potential issue in video processing or not.

20. (canceled)

21. The non-transitory computer-readable medium of claim 19, wherein the CNN model indicates, for each of the set of one-dimensional images, whether a given one-dimensional image in the set of one-dimensional images represents the potential issue in video processing or not.

22. The non-transitory computer-readable medium of claim 21, wherein the code for determining determines whether the set of values represent the potential issue based at least in part on determining whether the one-dimensional image is similar to a subset of the set of one-dimensional images indicated as having the potential issue in video processing.

23. The non-transitory computer-readable medium of claim 19, wherein the different performance metrics include a measurement of frames-per-second.
